(19) United States
(12) Patent Application Publication
(10) Pub. No.: US 2008/0212175 A1
(43) Pub. Date: Sep. 4, 2008

(54) Telescope Mount

(76) Inventor: Davide Agnetti, Lomazzo (Como) (IT)

Correspondence Address: SHOEMAKER AND MATTARE, LTD, 10 POST OFFICE ROAD - SUITE 110, SILVER SPRING, MD, 20910, US

(21) Appl. No.: 10/597,540

(22) PCT Filed: Feb. 17, 2004
(86) PCT No.: PCT/IT2004/000064

§ 371 Date: Feb. 5, 2007

(51) Int. Cl. G02B 23/16; G02B 7/00

(52) U.S. Cl. 359/429; 359/811

(57) ABSTRACT

A mounting and adjustment device for an optical observation system includes at least one optical observation instrument and a pedestal, and at least one element integrally associable with said optical observation instrument and at least one element integrally associable with the pedestal. The at least one element is also integrally associable with the optical observation instrument and the at least one element integrally associable with the pedestal is operatively connected in a pivoting manner to at least one pivoting fulcrum and is pivotable around pivoting axes positioned transversely with respect to one another. The device additionally comprising adjustment bodies for the operation of the pivoting.

The present invention relates to a telescope mounting, in particular for a telescope suitable to photograph celestial bodies with appreciable relative motion.

The observation and photography of celestial bodies, such as stars, planets, comets and the like, is a very widespread practice, both at the professional and amateur levels. Even the most inexpensive telescopes are equipped with a polar axis and appropriate tracking means able to follow terrestrial rotation, with the effect of keeping the celestial body to be observed or photographed in alignment with the telescope eye piece. However, such type of tracking is not sufficient if the object to be followed displays relative motion with respect to the firmament, as in the case of planets, comets and asteroids. More sophisticated systems, equipped with secondary tracking means, able to follow the relative motion of such heavenly bodies, and with a computerised system which allows the accurate and automatic positioning of the telescope for tracking the heavenly body, have therefore been perfected.

These problems are further enhanced in the case of photography of celestial bodies in general, and of objects endowed with relative motion in particular. Indeed, in such a case the eye piece of the telescope is connected to a traditional or digital camera, thus making direct control of the perfect alignment of the telescope with the object to be photographed by the observer impossible. Indeed, it has to be considered that the exposure times in these cases may also be very long (30-60 minutes), and it is hence not to be ruled out that, due for example to ground vibrations, the telescope becomes misaligned, thus thwarting the outcome of the photograph. Such a problem has been resolved by coupling a second telescope with a wider field angle, known as “photoguide”, to the telescope, integrally mounted onto the main telescope, typically on the main telescope body. The photoguide is directed towards the same celestial body which it is desired to photograph, or towards a different reference celestial body (normally, a bright star) and hence allows the observer to continuously monitor the correct tracking of the telescope.

The telescopes of this type therefore comprised of the main telescope, the photoguide and the respective finder scopes, each in turn mounted on the body of the corresponding telescope. The equipment is fixed onto a polar mounting which naturally requires, as usual, an adequate counterweight in order to balance the weight of the telescopes. The mounting is then set in place on a tripod.

Such apparatus however, has some considerable drawbacks. The aforesaid computerised systems for telescope and/or photoguide tracking are very efficient, but also extremely expensive and often not within the reach of an amateur observer. However, in the absence of such automated systems, photoguide tracking is extremely difficult. Indeed, the systems currently in use for the adjustment of the photoguide and finders are constituted by a ring mount into which the scope body is inserted, onto which two or three adjustment screws act which, depending on how they are turned, allow the orientation of the scope into the desired position. The system described is however somewhat imprecise and does not therefore allow the accurate adjustment of the instrument, as would indeed be required for its application in photography.

Another drawback is associated with the overall weight of the telescope and mount. Indeed, it is known that in order to perform astronomical observations and in particular for photography, it is necessary to position the telescope away from bright light sources and in a location characterised by an extremely clear atmosphere. Normally, such conditions occur in high mountainous locations, which require the manual transport of the telescope to positions not served by carriageable roads. It is thus evident that the weight of the instrument has a negative influence on its transportability.

The problem which lies at the heart of the present invention is therefore that of providing an instrument which overcomes the inherent drawbacks in the state of the art devices.

Such a problem is overcome by a mounting and adjustment device for an optical observation instrument and by a system for astronomical observation including said device, such as described in the enclosed claims.

Further characteristics and advantages of the astronomical observation system forming the object of the present invention will mostly arise from the description of some example embodiments, made in the following by way of non-limiting indication, with reference to the following figures:

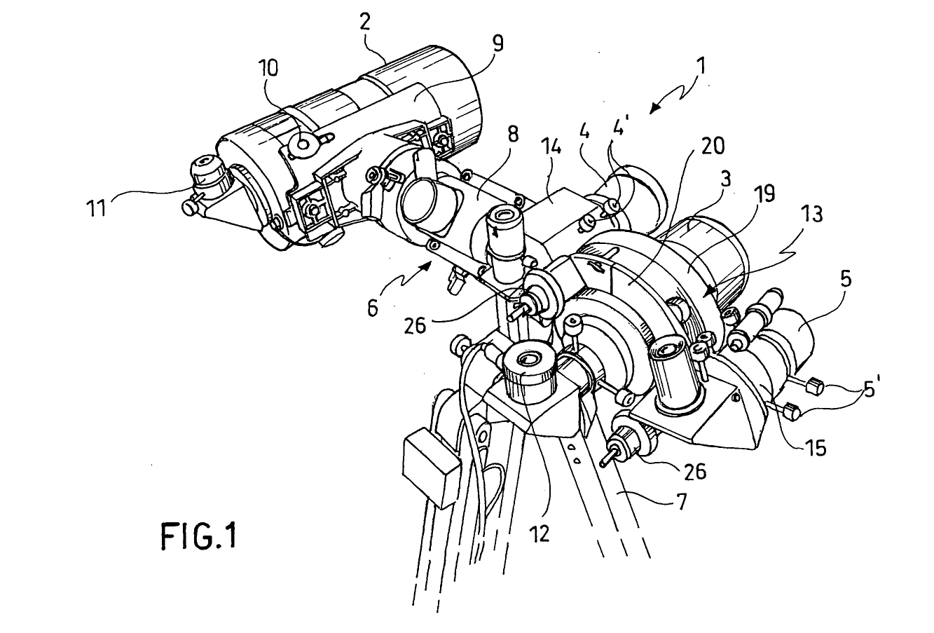

FIG. 1 represents a perspective view of the telescope assembly set on the mounting of the invention;

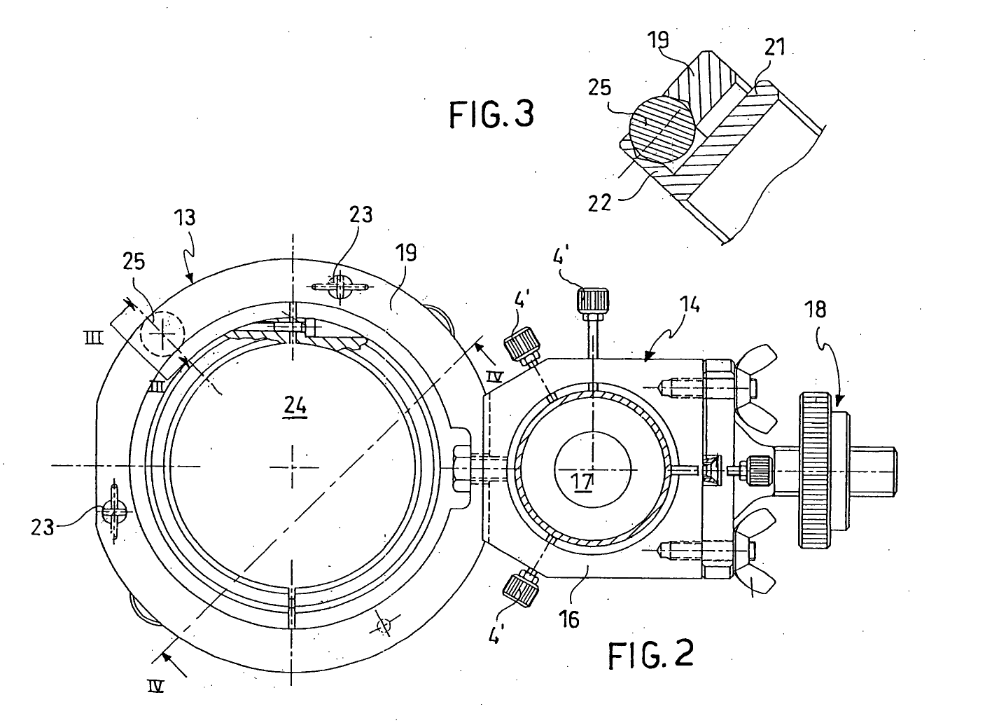

FIG. 2 represents a sectional plan view of a detail of the mounting of the invention;

FIG. 3 represents a view of a detail in accordance with the section taken along III-III of FIG. 2;

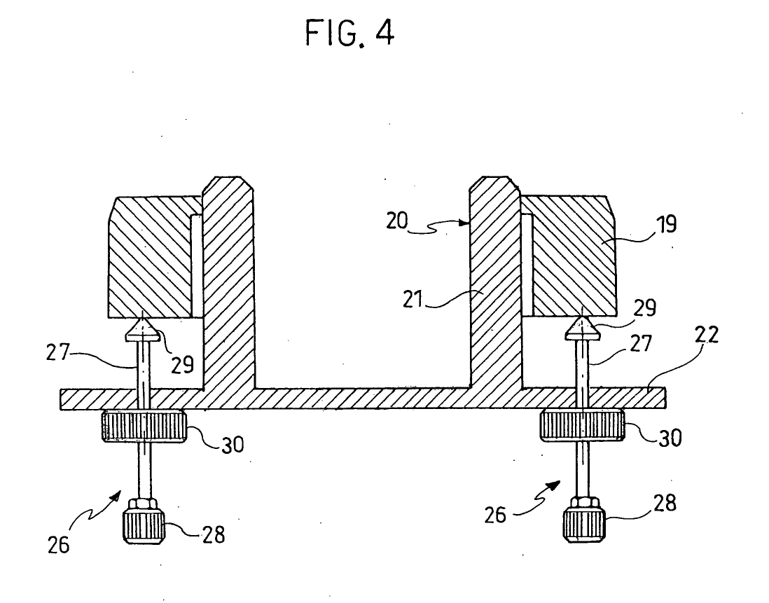

FIG. 4 represents a view in accordance with the section taken along IV-IV of FIG. 2;

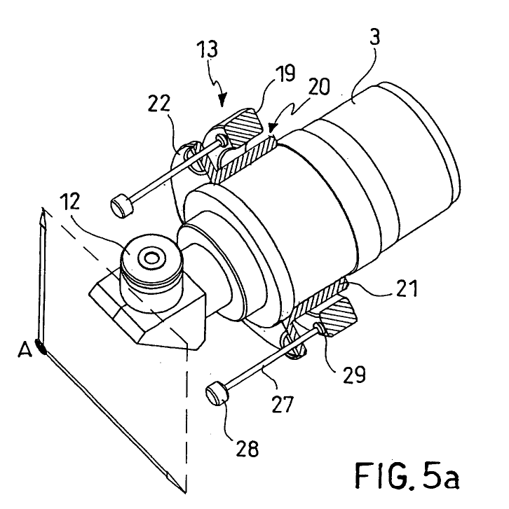

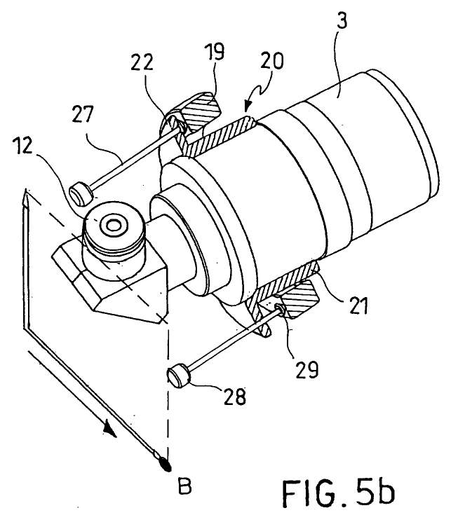

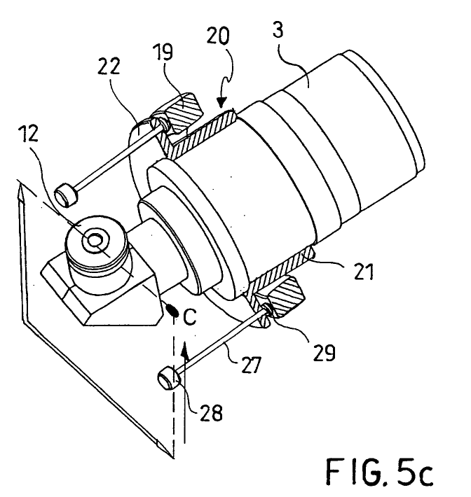

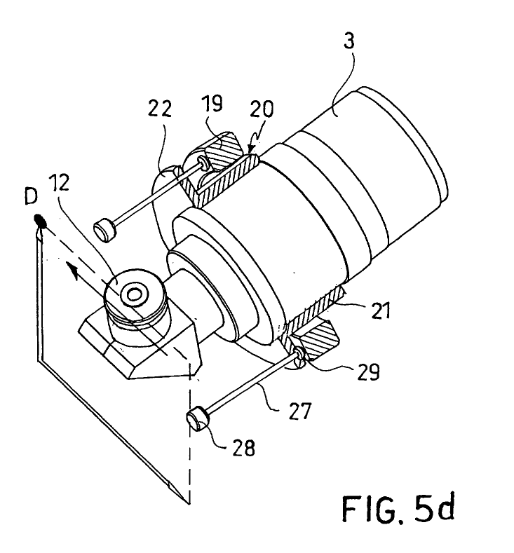

FIGS. 5a, 5b, 5c and 5d show a sequence of the possible adjustment positions of the device in accordance with the invention;

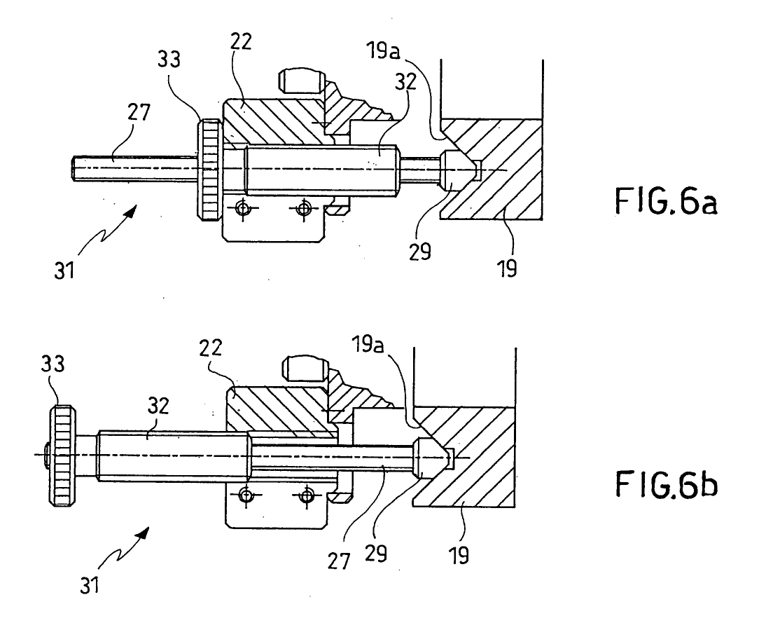

FIGS. 6a and 6b show a side view section of the adjusting means in a second embodiment of the invention, in two different operating positions;

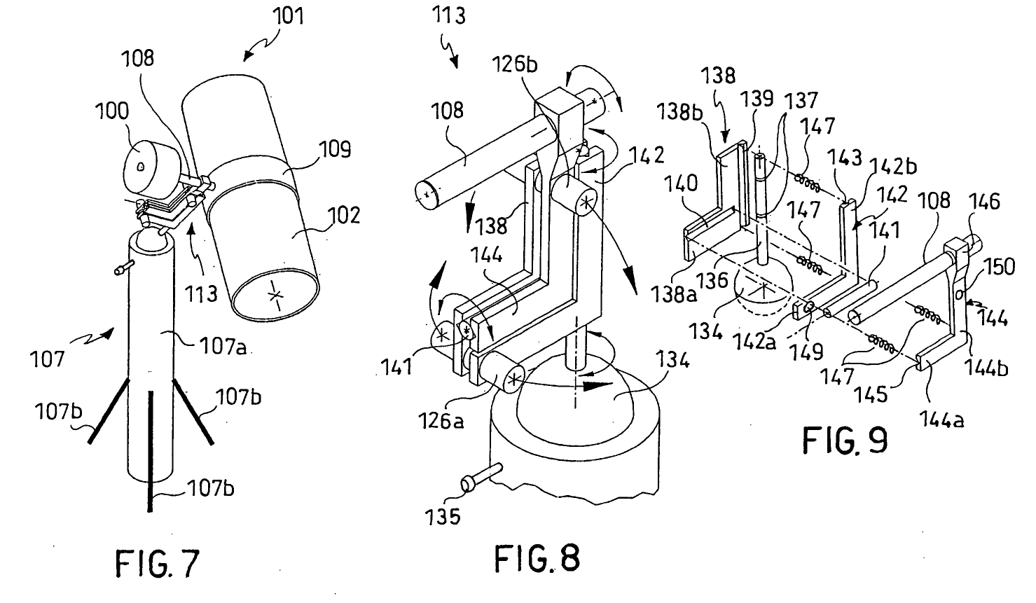

FIG. 7 represents a perspective view of the telescope assembly with the mounting in accordance with a third embodiment of the invention;

FIG. 8 represents a perspective view of a detail of the mounting of FIG. 7;

FIG. 9 represents an exploded view of the mounting of FIG. 8;

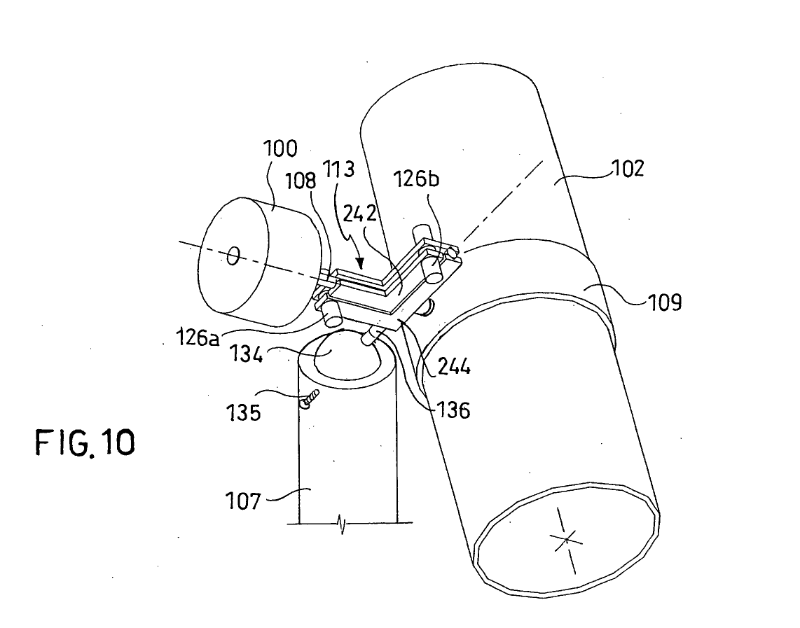

FIG. 10 represents a perspective view of the telescope assembly with the mounting in accordance with a fourth embodiment of the invention;

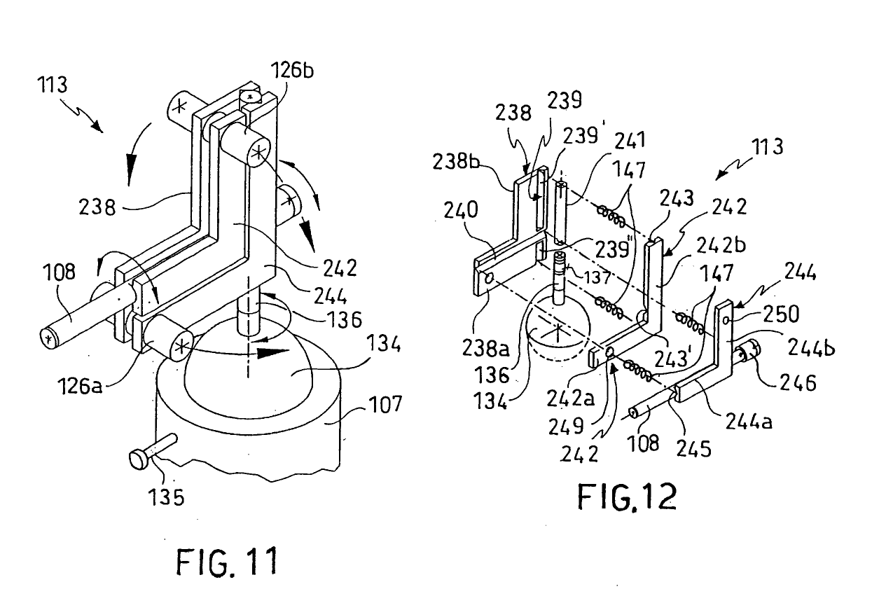

FIG. 11 represents a perspective view of a detail of the mounting of FIG. 10;

FIG. 12 represents an exploded view of the mounting of FIG. 11;

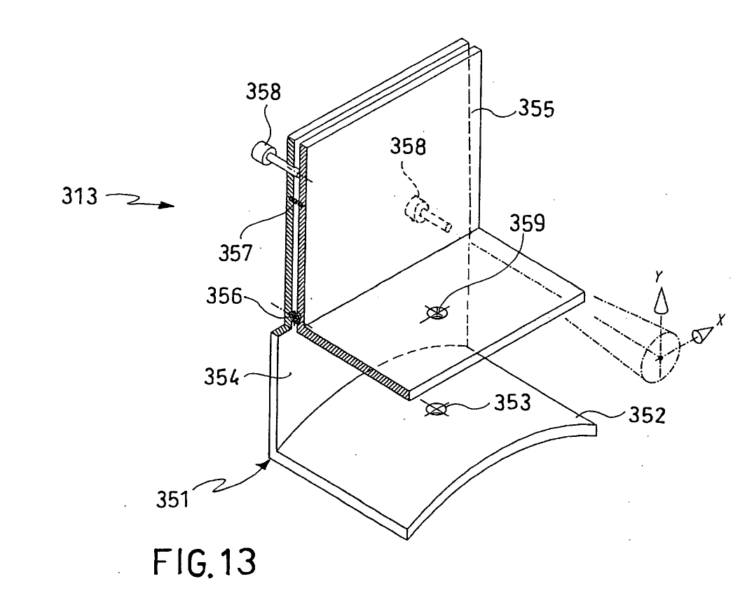

FIG. 13 represents a perspective view in partial cross section of a fifth embodiment of the mounting of the invention;

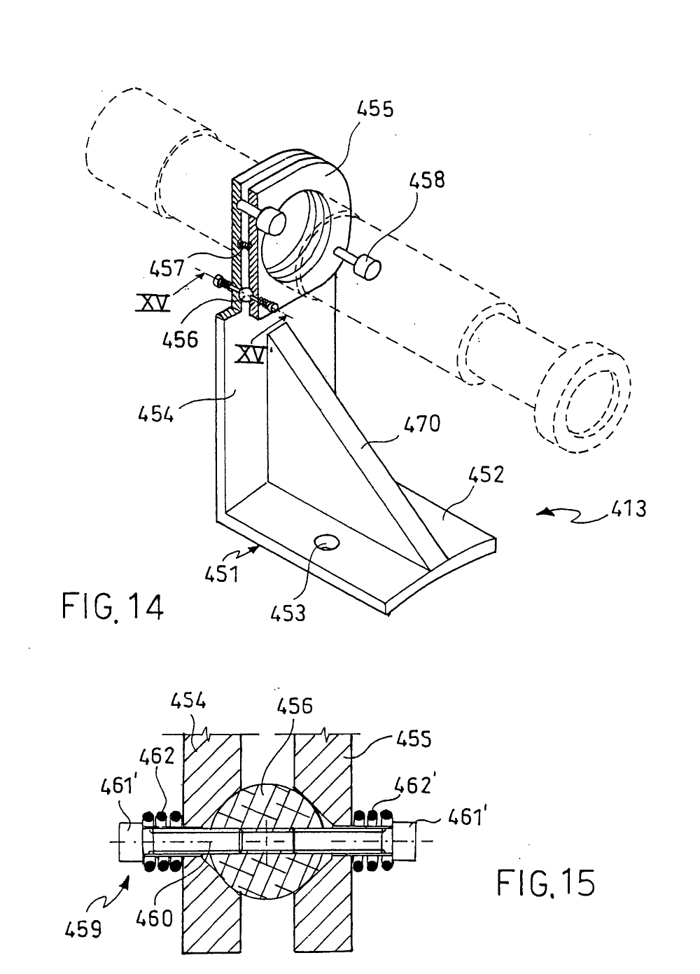

FIG. 14 represents a perspective view in partial cross section of a sixth embodiment of the mounting of the invention;

FIG. 15 represents a cross sectional view taken along the line XV-XV′ of a detail of FIG. 14.

With reference to the figures, the astronomical observation system in accordance with the invention is indicated overall by the number 1. It comprises a main telescope 2, a photoguide telescope 3, the corresponding viewfinder scopes 4, 5 and a mounting base 6.

As usual, the mounting base 6 is set on a pedestal 7, in the example, a tripod, of which a partial view of the legs is shown.

The mounting base 6 comprises a counter-balance bar 8, at one end of which the means of fixing 9 for the telescope 2 are fixed. Such means of fixing 9, of entirely conventional type, are for example constituted by a supporting sleeve or yoke, into which is inserted or on which is placed the instrument, equipped in their turn with appropriate fixing screws 10 in order to hold the telescope in position.

The telescope 2 may be one of various types, such as a refractor, reflector, etc., and comprises an eye piece 11 to which may be fixed, in the known manner, means for taking photographs, such as a traditional or digital camera (not shown).

The counter balance bar 8 comprises underneath the means of fixing to the tripod 7.

At the opposite end of said counter-balance bar 8 are located the photoguide telescope 3 and the finder scopes 4, 5 for the main telescope and the photoguide respectively. This is the first important aspect of the invention, in that the positioning of the photoguide in place of the counterweight, conventionally used in known telescopes, allows a significant reduction in the overall weight of the system, thus improving the transportability.

The embodiment shown in FIG. 1 foresees the arrangement in series of the finder scope 4 the main telescope 2, the photoguide telescope 3 and the finder scope 5 for the photoguide itself. It is apparent that any other combination which results in the same or similar balancing of the weights would be possible without, despite this, departing from the scope of protection of the present invention.

The finder scopes 4, 5 are housed in appropriate mountings 14, 15 equipped with adjusting screws 4′, 5′, respectively, for the setting and locking in position of said scopes.

The photoguide telescope 3 comprises, in turn an eye piece 12. Said eye piece 12 may comprise an illuminated grid system in order to assist with tracking. The photoguide telescope 3 is housed within appropriate means for mounting and adjustment 13.

In FIG. 2 is shown the mounting assembly 14 for the finder scope 4 for the main telescope 2 and the means for mounting and adjusting 13 the photoguide telescope 3.

The mounting 14 comprises a body 16 having a tubular housing 17 with a diameter adapted to housing the finder scope 4. Three adjusting screws 4′ are located on said mounting with their distal ends protruding inside said tubular housing 17 so as to act upon the body of the finder scope and thus constitute means for the adjustment and locking of the same.

To one side of the mounting 14 is fixed a ferrule 18 for connecting to the counter balance bar 8. At the opposite side of the mounting 14 are instead fixed, preferably through a screw-drive system, said mounting and adjusting means 13 for the photoguide telescope 3.

The mounting and adjusting means 13 comprise a circular element 19, integral with the mounting 14 and the counter balance bar 8, and a pivoting element 20. The pivoting element 20, when viewed in cross section, has an L-shaped profile, being constituted by a sleeve 21 and by an outwardly projecting flange 22. The internal diameter of the circular element 19 is greater than the outer diameter of the sleeve 21, the two elements 19, 20 being arranged coaxially, with the sleeve 21 housed within the through hole of the circular element 19. The internal diameter of the sleeve 21 is such as to permit its housing the photoguide telescope 3 within the resulting through hole 24. The photoguide is held in position by appropriate locking means, not shown.

The circular element 19 and the pivoting element 20 are assembled together using sprung means of fixing 23 which allow keeping the system assembled and under tension. Between the circular element 19 and the pivoting element 20 is operationally positioned a pivoting fulcrum 25, which in the example shown in FIG. 3 takes the form of a sphere housed within appropriate seating formed on the opposing surfaces of the flange 22 and the circular element 19.

The mounting and adjusting means 13 comprise adjustment devices 26. In the embodiment shown in FIG. 4, such adjustment devices 26 are a micrometric screw comprising a stem 27 bearing a head 28 at the end nearest to the user, and a cap 29 at the distal end. The stem 27 passes through a through hole made in the body of the flange 22. The cap 29 presses onto the surface of the circular element 19 facing the flange 22. The stem 27, is threaded over at least a part of its outer surface, and used for screwing into a manoeuvring female screw 30. Through the rotation of said manoeuvring female screw 30, the female screw itself is moved along the stem 27, thus altering the distance between the female screw 30 and the cap 29 and, consequently, the distance between the flange 22 and the circular element 19, as will be better described in the following. The female manoeuvring screw 30 comprises a vernier reader (not shown) calibrated on the angulations of the celestial coordinates (arc seconds). The mounting and adjusting means 13 comprise two adjustment devices 26 arranged so as to form a right angle with the pivoting fulcrum 25. In other words, the straight line joining the axis of the stem 27 of a first adjustment device 26 to the pivoting fulcrum 25, and the straight line joining the latter to the axis of the stem 27 of a second adjustment device 26 are arranged at 90°.

With reference to FIGS. 5a to 5d, the operation of the device of the invention will now be described.

As is known, the most widely used celestial coordinate system is the so-called “equatorial coordinate system”. In such system, the-base ring is the celestial equator, the positive hemisphere is the boreal, the abscissa is called right ascension and the ordinate is called declination. Since this is dealing with spherical curvilinear coordinates, the position of celestial bodies is given in angulations along the right ascension and the declination. The arc second (corresponding to 1/3600 of a degree) is the minimum measurement of angle of rotation normally used in non professional instruments.

As explained previously, the rotation of the female manoeuvring screw 30, adjusted with the aid of the vernier reader, allows the pivoting element 20 to pivot with respect to the fulcrum 25. Now, it is apparent that if only one of the two adjustment devices 26 is operated, the fulcrum 25 and the second adjustment device 26 will have the role of a hinge having an axis of pivoting formed by the straight line joining the fulcrum 25 and said second adjustment device 26. Consequently, due to the right angled arrangement of the fulcrum 25 and the two adjustment devices 26, the photoguide 3, integral to the pivoting element 20, will be moved along a straight line perpendicular to the aforesaid axis of pivoting. By making the two perpendicular straight lines coincide with the right ascension and with the declination, respectively, in a mounting with a polar axis, easy and precise tracking of the photoguide 3 on the celestial body of interest will be achieved.

In FIG. 5a is shown, by way of example, a first possible position of the mounting and adjusting means 13, wherein the planes of the circular element 19 and the pivoting element 20 are essentially parallel. Such positions correspond, in the example, to the origin of the axes indicated in the drawing by a bold circle (position A).

As shown in FIG. 5b, operation of a first adjustment device 26 causes the pivoting of the element 20 and the consequent displacement of the photoguide along the abscissa until reaching position B.

FIG. 5c shows an additional tracking position (position C) obtained by the operation of also the second adjustment device 26.

As shown in FIG. 5d, the first adjustment device 26 is returned to the starting position, thus obtaining the displacement of the photoguide 3 up to position D.

In accordance with a second embodiment of the invention, shown in FIGS. 6a and 6b, the adjustment devices 26 are constituted by a differential screw 31. The differential screw is a known adjustment device which allows very careful precision. In the present case resolutions of 1-3 arc seconds may be obtained.

The differential screw 31 comprises a stem 27 fitted with a cap 29 which presses on the surface of the circular element 19 turned towards the flange 22. Said striking surface comprises a seat 19a for the cap 29 of a shape such as to block the rotation of the stem 27. For example, the cap 29 and the seat 19a will have complementary shapes and such shape may be polygonal. The device additionally comprises a tubular female screw 32, threaded internally and externally and fitted with an operating handle 33. With the operating handle 33 is associated a vernier reader (not shown). The threading of the tubular female screw 32 is coupled with the internal threading of the hole passing through the wall of the flange 22 wherein said differential screw 31 is inserted. The outer threading of the female screw 32 and outer threading of the stem 27 have different pitches. The movement of the female screw 32 along the stem 27 is proportional to the difference in pitches of the two screws. For example, if the female screw 32 has a pitch of 1.5 mm and the threading of the stem 27 has a pitch of 1 mm, a pitch differential of 0.5 mm per revolution is obtained. With 5° of reciprocal rotation, approx. 7 microns of displacement are obtained. In FIGS. 6a and 6b are shown two different adjustment positions of the differential screw used in the invention. It is thus apparent that the differential screw 31 allows the attainment of considerable precision in the adjustment of the right ascension and the declination in the instrument of the present invention.

As mentioned, differential screws are known and commercially available. Differential screws with the differential pitch desired however may be easily obtained by starting from two screws of different diameters and different pitches, by boring and threading the core of the larger screw.

In accordance with an additional embodiment of the invention, shown in FIGS. 7, 8 and 9, the means of mounting and adjustment, indicated by the number 113, are directly applied to the main telescope. Indeed, such an embodiment does not comprise a photoguide telescope.

As shown diagrammatically in FIG. 7, the system for astronomical observation 101 comprises a telescope 102, means for mounting and adjustment 113 for the telescope, and a pedestal 107. In the example, the pedestal 107 consists of a column 107a, fitted with legs 107b in the form of a tripod. The upper end of the column 107a ends in a ball joint 134 in order to flexibly connect said mounting and adjusting means 113 to the pedestal 107. Means for locking in position 135 are provided in order to maintain the ball joint in a defined position. In the example, such means are constituted by an adjustable screw which passes through the wall of the column 107a and presses on the ball joint 134. Depending on the pressure which the screw exerts on the ball, the release or the locking of the joint will be obtained.

As shown in FIGS. 8 and 9, the means for mounting and adjustment 113 are connected through a stem 136 to the ball joint 134. The stem 136 may comprise one or more pads 137. In FIG. 9 are shown two pads 137. The stem 136 has cylindrical shape and may be either solid or hollow.

The means for mounting and adjustment 113 comprise a first L-shaped element 138, i.e. an element comprising two plate-shaped arms, one horizontal arm 138a and a vertical arm 138b, arranged at right angles to one another. By the terms “horizontal arm” and “vertical arm”, here and hereinafter in the present description, are meant the relative positioning of the two arms of the device depicted in the diagram, without any particular reference to the positioning of the same within the device when in use, in which the L-shaped elements may also find themselves in inclined positions.

On one face of said first L-shaped element 138 there is a vertical groove 139 and a horizontal groove 140. The horizontal groove 140 has a length which is inferior to the length of the side of the L-shaped element 138, so as not to intersect with the vertical groove 139, and is located in a position close to the edge of the shorter side of the horizontal arm 138a. The vertical groove 139 is instead placed in a position close to the edge of the longer side of the vertical arm 138b. Both grooves have an essentially semi-cylindrical profile. In particular, the vertical groove 139 has such shape and length as to house a first semi-cylindrical part of the stem 136, whilst the horizontal groove 140 has such shape and length as to house a first semi-cylindrical part of a pin 141.

The means for mounting and adjustment 113 comprise a second L-shaped element 142, intended to oppose the first L-shaped element 138. Said second L-shaped element 142 is constituted by two right-angled arms 142a, 142b having lengths essentially corresponding to the longer sides of the first L-shaped element 138, with which they are intended to meet up with. The vertical arm 142b has thus, on the face intended to oppose the first L-shaped element 138, a vertical groove 143, of essentially semi-cylindrical shape and complimentary to the vertical groove 139 of the first L-shaped element 138. Said vertical grooves 139, 143 will hence come to constitute a seating for the stem 136.

A third L-shaped element 144 is additionally foreseen. Such third L-shaped element 144 is constituted by two right-angled arms 144a, 144b having lengths essentially corresponding to those of the shorter sides of the first L-shaped element 138 and intended to oppose and to meet up with said shorter sides of the first L-shaped element 138. The horizontal arm 144a has a horizontal, essentially semi-cylindrical shaped groove 145, complimentary to the horizontal groove 140 of the first L-shaped element 138. Said horizontal grooves 140, 145 will hence come to constitute a seating for the pin 141.

At the upper end of the vertical arm 144b of the third L-shaped element 144 is borne, by a supporting block 146 fitted with pads, a counter balance bar 108. The telescope 102 is housed within a restraining band 109, which is in turn fixed to the counter balance bar 108. The counter balance bar 108 carries a counterweight 100 at its opposite end. Through an appropriate friction clutch (not shown), the counter balance bar may rotate, together with the telescope 2, around its axis which, as will be better described in the following, corresponds to the axis of the right ascension. Analogously, rotation around the axis of the stem 136, assisted by a friction clutch (not shown), will correspond to rotation around the axis of the declination.

The first, second and third L-shaped elements 138, 142, 144 are assembled and held together by appropriate resilient means, such as traction springs 147, visible in the exploded view of FIG. 9.

On the second and third L-shaped elements 142, 144 some holes 149, 150 are made, with the first hole 149 located in close proximity to the distal end of the horizontal arm 142a of the first L-shaped element 142, and the second hole 150 located in close proximity to the distal end of the vertical arm 144b of the third L-shaped element 144.

When the device is assembled, as shown in FIG. 8, it is completed with appropriate adjustment devices 126a, 126b such as the micrometric or differential screws described previously and shown in FIGS. 4, 6a, 6b. The adjustment devices 126a are housed within the holes 149, whilst adjustment devices 126b are housed within the holes 150 of the L-shaped elements 142, 144, respectively. The vernier reader (not shown) may be advantageously associated with such adjustment devices 126a, 126b.

Operation of the mounting and adjusting means 113 is as follows. The axis of the stem 136 constitutes the polar axis of the telescope 2 and is thus aimed towards the pole star. Following this adjustment, the ball joint 134 is locked in position by the corresponding means of fixing 135. At this point, by freeing the friction clutches (not shown) present along the stem 136 and the counter balance bar 108, it is possible to perform coarse manual tracking of the telescope 2 in accordance with the celestial coordinates. In particular, displacements in declination will be given by rotation around the axis of the stem 136, whilst right ascension displacements will be obtained by rotation around the axis of the balance bar 108.

Once the coarse tracking has been performed, the friction clutches are locked and precision tracking is then carried out by means of the adjustment devices 126a, 126b. By working the adjustment devices 126b pivoting of the third L-shaped element 144 is obtained around the pin 141, which then acts as a pivoting fulcrum, thus realising movement of the telescope in accordance with the right ascension. Instead, by operating adjustment devices 126a, the second L-shaped element 142 pivots around the stem 136, which in turn acts as a pivoting fulcrum, and thus movement in accordance with the declination is realised. Such movements are of small extent and high precision, such as previously described for the mounting and adjusting means for the photoguide telescope.

The additional embodiment of the invention shown in FIGS. 10, 11 and 12 comprises mounting and adjusting means which are directly connected to the main telescope, analogously to the embodiment of FIGS. 7-9. With reference to the embodiment, which will now be described with reference to FIGS. 10-12, parts and elements corresponding to those of the previous embodiment will be indicated by the same numbers.

Again in such embodiment, the means for mounting and adjustment 113 are connected through a stem 136 to the ball joint 134. The stem 136 may comprise one or more pads 137. In FIG. 9 is shown one pad 137. The stem 136 has a cylindrical shape and may be either solid or hollow.

The means for mounting and adjustment 113 comprise a first L-shaped element 238, i.e. an element comprising two plate-shaped arms, one horizontal arm 238a and a vertical arm 238b, arranged at right angles to one another. On one face of said first L-shaped element 238 there is a vertical groove 239 and a horizontal groove 240. The horizontal groove 240 extends essentially along the entire length of the horizontal arm 238a, between its two ends, so as to intersect the vertical groove 239, and is located in a position close to the edge of the shorter side of the horizontal arm 238a. Consequently, the vertical groove 239 is divided into an upper part 239′ and a lower part 239″, placed respectively above and below the intersection point with the horizontal groove 240. The vertical groove is additionally located in the part which is close to the edge of the longer side of the vertical arm 238b. Both grooves have an essentially semi-cylindrical profile. In particular, the lower part 239″ of the vertical groove 239 has such shape and length as to house a first semi-cylindrical part of the stem 136, whilst the upper part 239′ of the vertical groove 239 has such shape and length as to house a first semi-cylindrical part of a pin 241. On the other hand, the horizontal groove 240 has such shape and length as to house a first semi-cylindrical part of the balance bar 108.

The means for mounting and adjustment 113 comprise a second L-shaped element 242, intended to oppose the first L-shaped element 238. Said second L-shaped element 242 is constituted by two right-angled arms 242a, 242b having lengths essentially corresponding to the longer sides of the first L-shaped element 238, with which they are intended to match up with. The vertical arm 242b thus has, on the face intended to oppose the first L-shaped element 238, a vertical groove 243, of essentially semi-cylindrical shape and complimentary to the vertical groove 239 of the first L-shaped element 238. Consequently, also said vertical groove 243 is interrupted crosswise by a horizontal groove complimentary to the part of the horizontal groove 240 of the first L-shaped element 238 with which it is intended to match up with. Said vertical grooves 239, 243 will hence come to constitute a seating for the stem 136.

A third L-shaped element 244 is additionally provided. Such third L-shaped element 244 is constituted by two right-angled arms 244a, 244b having lengths essentially corresponding to those of the shorter sides of the first L-shaped element 238 and intended to oppose and to meet up with said shorter sides of the first L-shaped element 238. The horizontal arm 244a has a horizontal, essentially semi-cylindrical shaped groove 245, complimentary to the horizontal groove 240 of the first L-shaped element 238. Said horizontal grooves 240, 245 together with the horizontal groove 243′ of the second L-shaped element 242, will hence come to constitute a seating for the counter balance bar 108.

The telescope 102 is housed within a restraining band 109, which is in turn fixed to the counter balance bar 108. The counter balance bar 108 carries a counterweight 100 at its opposite end. Through an appropriate friction clutch 246, the counter balance bar may rotate, together with the telescope 2, around its axis which, as described previously, corresponds to the axis of the right ascension.

Analogously, rotation around the axis of the stem 136, assisted by a friction clutch (not shown), will correspond to rotation around the axis of the declination.

The first, second and third L-shaped elements 238, 242, 244 are assembled and held together by appropriate resilient means, such as traction springs 147, visible in the exploded view of FIG. 12.

On the second and third L-shaped elements 242, 244 holes 249, 250 are made, with the first hole 249 located in close proximity to the distal end of the horizontal arm 242a of the first L-shaped element 242, and the second hole 250 located in close proximity to the distal end of the vertical arm 244b of the third L-shaped element 244.

When the device is assembled, as shown in FIG. 11, it is completed with appropriate adjustment devices 126a, 126b such as the micrometric or differential screws described previously and shown in FIGS. 4, 6a, 6b. The adjustment devices 126a are housed within the hole 249, whilst adjustment devices 126b are housed within the hole 250 of the L-shaped elements 242, 244, respectively. Vernier readers (not shown) may be advantageously associated with such adjustment devices 126a, 126b.

The device described herein, which has a more compact and balanced form than the analogous device shown in FIGS. 7-9, has the same operation as the latter and hence will not be described in any further detail.

Now, with reference to FIG. 13, the embodiment shown therein represents means for mounting and adjustment 313 for photographic means such as a camera for taking celestial photographs. The device comprises a fixing base 351 to the telescope. The fixing base 351 in turn comprises a fixing piece 352 in the form of a plate, curved so as to follow the curvature of the cylindrical body of the telescope and to be rested upon it. Upon said fixing piece 352 is formed a through hole 353 for attachment to the telescope, using appropriate means of fixing, not shown.

From the fixing piece 352 protrudes, in an essentially perpendicular direction, the mounting piece 354. To said mounting piece 354 is operationally associated, in a pivotable manner, a yoke element 355. The yoke element 355 is held against the mounting piece 354 by means of appropriate resilient means 357, such as traction springs, and is hinged onto the pivoting fulcrum 356, which in the example is constituted by a sphere.

The device 313 comprises two adjustment devices 358, entirely corresponding to the adjustment devices 26, such as the previously described micrometric or differential screws. Said adjustment devices 358 are arranged so as to form a right angle with the pivoting fulcrum 356. In other words, the straight line joining the axis of the stem of a first adjustment device 358 to the pivoting fulcrum 356, and the straight line joining the latter to the axis of the stem of a second adjustment device 358 are arranged at 90°. The yoke element 355 comprises two flat pieces arranged perpendicularly to one another, a first piece facing towards the mounting piece 354 of the mounting base 351, the second piece projecting perpendicularly outwards from the latter. On the latter piece is provided a through hole 359 for housing means of fixing (not shown) for a camera. For example, such means of fixing may be constituted by a screw for fixing the camera through the threaded hole normally located on its base.

The operation of such a device 313 is entirely consistent with that previously described for the other embodiments of the invention, and hence does not require any further explanation.

In FIG. 14 is shown a sixth embodiment of the invention representing the mounting and adjusting means for a finder scope.

The mounting and adjusting means 413 comprise a yoke base 451 having a fixing piece 452 in the form of a plate, curved so as to follow the curvature of the cylindrical body of the telescope and to be rested upon it. Upon said fixing piece 452 is formed a through hole 453 for attachment to the telescope, using appropriate means of fixing, not shown. The fixing piece may comprise a second through hole (not shown) in order to increase the stability of the fixing of the scope to the main telescope.

The mounting piece 454 projects in an essentially perpendicular direction from the fixing piece 452. A reinforcing rim 470 joins the two parts 453, 454 of the yoke base 451.

With the mounting piece 454 is operatively associated, in a pivoting manner, a bored plate 455, the through hole of which has such shape and size as to house the scope. Appropriate removable means of fixing (not shown) may be provided so as to allow the fixing and removal of the scope from the bored plate 455.

The bored plate 455 is held against the mounting piece 454 by means of appropriate resilient means 457, such as traction springs, and is hinged on the pivoting fulcrum 456, which, in the example, is constituted by a sphere.

The device 413 comprises two adjustment devices 458, entirely corresponding to the adjustment devices 26, such as the previously described micrometric or differential screws. Said adjustment devices 458 are arranged so as to form a right angle with the pivoting fulcrum 456. In other words, the straight line joining the axis of the stem of a first adjustment device 458 to the pivoting fulcrum 456 and the straight line joining the latter with the axis of the stem of a second adjustment device 458 are arranged at 90°.

In one preferred embodiment of the invention, shown in FIG. 15, the pivoting fulcrum 456 comprises means of restraining 459, in order to maintain the fulcrum 456 which, in the example, is a sphere, in position within its seating.

Such means of restraining 459 comprise a stem 460 which passes through the walls of the mounting piece 454 and the bored plate 455, as well as the pivoting fulcrum 456 itself, which will hence be bored for this purpose.

The stem 460 terminates at both ends in heads 461, 461′ with diameters greater than that of the stem 460. The stem 460 has length such as to protrude externally over both sides of the device. Appropriate resilient means 462, 462′, such as for example cup springs, are arranged so as to be held between the heads 461, 461′ and the mounting piece 454 and the bored plate 455, respectively.

Also in this case, the operation of the device 413 is entirely analogous to those previously described.

The device of the invention has numerous advantages.

The means for mounting and adjustment 13, 113, 313, 413 in accordance with the invention have the advantage of allowing extremely accurate tracking, with resolutions in the order of 1-3 arc seconds, through a device of simple construction and extremely restricted cost.

Such device is furthermore compact and light and allows for easy transportation, a characteristic which is very advantageous for the particular use of the instrument on small telescopes for amateur use.

The same base of the telescope, comprising said mounting and adjusting means 13, in the embodiment wherein the photoguide is in the place of the counterweight, allows a significant reduction both in the weight and in the dimensions of the equipment.

It is apparent that only some particular embodiments of the device forming the subject of the present invention have been described, to which the expert in the art will be able to bring about all those modifications necessary for its adaptation to particular applications, without moreover diverging from the scope of protection of the present invention.

For example, the means of pivoting, in the example, constituted by a sphere or by a cylinder, may be substituted by any other pivoting member known to any expert in the art, such as springs, articulated hinges, etc.

The adjustment devices 26 in the examples, micrometric or differential screws, will generally comprise any manually or motorised operated adjustment device which allows equal or better resolution to that described in the present description.

The fixed and pivoting elements which compose the mounting and adjusting means in accordance with the invention, described herein in the form of rings or bored plates or L-shaped bars, may assume any shape which, despite keeping the functionality of the system unchanged, allow the achievement of greater ease of use or ergonomicity or a more attractive aesthetic appearance. Analogously, all the modifications dictated by the demands of the industrialisation of the device, such as particular proportionings of the individual parts or of the assembly, are included within the invention.

The above described adjustment devices may indifferently be mounted onto one or onto the other side of the mounting and adjusting means 13, 113, 313, 413. In other words, the cap 29 of the stem 27 may press upon a striking surface of the fixed element, i.e. of the element 19; 138, 142; 238, 242; 351; 451 integrally associable with the pedestal 7, 107, or on a striking surface of the pivoting element, i.e. the element 20; 138, 144; 238, 244; 355; 455 integrally associable with the optical observation instrument (2, 3). In general, it will be preferable that the female manoeuvring screw be oriented towards the operator.

1-26. (canceled)

27. A mounting and adjustment device for an optical observation system comprising at least one optical observation system and a pedestal, said device comprising at least one element integrally associable with said optical observation system and at least one element integrally associable with said pedestal, said at least one element integrally associable with said optical observation system and said at least one element integrally associable with said pedestal being operatively connected in a pivoting manner by at least one pivoting fulcrum and being pivotable around a pivoting axis arranged transversly with respect to one another, said device additionally comprising adjustment devices for the operation of said pivoting.

28. The mounting and adjustment device in accordance with claim 27, wherein said axes of pivoting are at right angles to one another and lie on a plane which is parallel to the plane in which lies said at least one element integrally associable with said pedestal.

29. The mounting and adjustment device in accordance with claim 28, comprising two adjustment devices arranged so as to form a right angle with the pivoting fulcrum.

30. The mounting and adjustment device in accordance with claim 27, wherein said adjustment devices comprise a micrometric screw comprising a stem bearing a head at the end closest to the user and a cap at the distal end, intended to press upon a striking surface of said at least one element integrally associable with said pedestal or of said at least one element integrally associable with said optical observation instrument, said stem, threaded over at least a part of its outer surface, being engaged by screwing with a female maneuvering screw, said female maneuvering screw preferably comprising a vernier reading device calibrated on the angulations of the celestial coordinates.

31. The mounting and adjustment device in accordance with claim 27, wherein said adjustment devices comprise a differential screw comprising a stem fitted with a cap intended to press upon a striking surface of said at least one element integrally associable with said pedestal or of said at least one element integrally associable with said optical observation instrument, said device additionally comprising a tubular female screw, threaded internally and externally, arranged coaxially outwith the stem, and equipped with an operating handle, the outer threading of the tubular female screw being coupled with the internal threading of a hole passing though the wall of said at least one element integrally associable with said pedestal or of said at least one element integrally associable with said optical observation instrument wherein said differential screw is inserted; the outer threading of the tubular female screw and outer threading of the stem having different pitches.

32. The mounting and adjustment device in accordance with claim 31, wherein said adjustment devices comprise a vernier reader calibrated on the angulations of the celestial coordinates.

33. The mounting and adjustment device in accordance with claim 31, said striking surface of said at least one element integrally associable with said pedestal or with said at least one element integrally associable with said optical observation instrument comprising a seating for the cap of such a shape as to block the rotation of the stem.

34. The mounting and adjustment device in accordance with claim 33, wherein said cap and said seating have complimentary shapes, preferably a polygonal shape.

35. The mounting and adjustment device in accordance with claim 27, wherein said element integrally associable with said optical observation instrument is pivoting with respect to said element integrally associable with said pedestal, said pivoting element having, in cross-section, an L-shaped profile and being constituted by a sleeve for the housing of said means of optical observation and by a flange projecting outwards; said element integrally associable with said pedestal being a circular element and being arranged coaxially with respect to said pivoting element, said sleeve being housed within the through hole of the circular element.

36. The mounting and adjustment device in accordance with claim 34, wherein said circular element and said pivoting element are assembled together through sprung means of fixing which provide for keeping the system assembled and under tension, between said circular element and said pivoting element is operatively placed a pivoting fulcrum.

37. The mounting and adjustment device in accordance with claim 36, wherein said pivoting fulcrum is a sphere.

38. The mounting and adjustment device in accordance with claim 27, comprising a first L-shaped element having a horizontal plate-shaped arm and a vertical plate-shaped arm, each arm having a longer side and a shorter side; a second L-shaped element opposite the first L-shaped element, having two arms of length essentially corresponding to the longer sides of the first L-shaped element, with which they are intended to meet up with; and a third L-shaped element opposite the first L-shaped element, having two arms of length essentially corresponding to that of the shorter sides of the first L-shaped element and intended to oppose and to match up with said shorter sides of the first L-shaped element; said device additionally comprising a first cylindrical pivoting fulcrum located within the complimentary seats formed in the vertical arms of said first and second L-shaped elements, and a second cylindrical pivoting fulcrum placed at right angles with respect to the first complimentary seatings formed in the horizontal arms of said first and third L-shaped elements; said device additionally comprising first adjustment devices operatively associated with the horizontal arms of said first and second L-shaped elements and second adjustment devices operatively associated with the vertical arms of said first and third L-shaped elements.

39. The mounting and adjustment device in accordance with claim 38, said device comprising a stem for connection to the pedestal of the optical observation system and a counter balance bar for the connection of said mounting and adjustment device to said optical observation instrument and to a counterweight, said optical observation instrument and said counterweight being positioned at the two ends of said counter balance bar.

40. The mounting and adjustment device in accordance with claim 39, wherein said stem is connected to the pedestal of said optical observation system through a ball joint in order to connect said mounting and adjustment device to the pedestal in an articulating manner, means of locking in position being provided in order to maintain the ball joint in a defined position.

41. The mounting and adjustment device in accordance with claim 40, comprising friction clutches positioned between said stem and said ball joint and/or between said counter balance bar and said optical observation instrument.

42. The mounting and adjustment device in accordance with claim 27, wherein said optical observation instruments are means for taking photographs such as a camera for celestial photography, said device comprising a fixing base to said optical observation instrument having a mounting piece, to said mounting piece being operatively associated, in a pivoting manner, a yoke element, said yoke element comprising two flat pieces arranged at right angles to one another, a first piece facing onto the mounting piece of the fixing base, a second piece projecting perpendicularly from the latter; said second piece comprising means of fixing to the means for taking photographs.

43. The mounting and adjustment device in accordance with claim 42, said device comprising two adjustment devices arranged so as to form a right angle with the pivoting fulcrum.

44. The mounting and adjustment device in accordance with claim 27, comprising a yoke base having a fixing piece to a telescope and a mounting piece operatively associated, in a pivoting manner, with a bored plate, the through hole of said bored plate having such shape and dimensions as to house an optical observation instrument such as a finder scope.

45. The mounting and adjustment device in accordance with claim 44, the pivoting fulcrum being constituted by a sphere, said device additionally comprising two adjustment devices arranged so as to form a right angle with the pivoting fulcrum.

46. The mounting and adjustment device in accordance with claim 27, said pivoting fulcrum comprising means of restraining in order to maintain the fulcrum in place within its seating.

47. The device in accordance with claim 46, wherein said means of restraining comprise a stem which crosses through the walls of said at least one element integrally associable with said optical observation instrument and of said at least one element integrally associable with said pedestal, and the pivoting fulcrum itself, said stem terminating at its two ends with heads of greater diameter than the stem; said stem having such a length as to protrude externally over both sides of the device; said means of restraining additionally comprising appropriate resilient means arranged between the heads and the surface of the mounting and adjustment device.

48. The mounting and adjustment device in accordance with claim 27, comprising resilient means, such as traction springs, for holding together said at least one element integrally associable with said optical observation instrument and said at least one element integrally associable with said pedestal.

49. An optical observation system comprising at least one mounting and an adjustment device of at least one optical observation instrument as described in claim 27.

50. An optical observation system comprising a first optical observation instrument, a second optical observation instrument, a mounting and adjustment device for said optical observation instruments and a pedestal to which said mounting and adjustment device is connected, characterised in that said mounting and adjustment device comprises a counter balance bar and that said first and second optical observation instruments are arranged at or in close proximity to the opposite ends of said counter balance bar in such a way as to achieve the balancing of the optical observation system.

51. The optical observation system in accordance with claim 50, wherein said first optical observation instrument is the main telescope and said second optical observation instrument is a photoguide telescope.

52. The optical observation system in accordance with claim 50, wherein said mounting and adjustment device comprises at least one optical observation system and a pedestal, at least one element integrally associable with said optical observation system and at least one element integrally associable with said pedestal, said at least one element integrally associable with said optical observation system and said at least one element integrally associable with said pedestal being operatively connected in a pivoting manner by at least one pivoting fulcrum and being pivotable around a pivoting axis arranged transversly with respect to one another, said device additionally comprising adjustment devices for the operation of said pivoting.
